(19) United States
(12) Patent Application Publication
(10) Pub. No.: US 2008/0158413 A1
(43) Pub. Date: Jul. 3, 2008

(54) Mouse adapted with a network camera

(76) Inventor: Hui-Hu Liang, Siu Shul Hsiang (TW)

Correspondence Address: TROXELL LAW OFFICE PLLC, SUITE 1404, 5205 LEESBURG PIKE, FALLS CHURCH, VA, 22041, US

(21) Appl. No.: 11/647,226

(22) Filed: Dec. 29, 2006

(51) Int. Cl. H04N 5/225

(52) U.S. Cl. 348/376

(57) ABSTRACT

A mouse adapted with a network camera to provide double benefits of operating as a mouse and a network camera includes a window disposed on a base of the mouse; a lens built in the window; a dustproof slide lid being placed on the window to protect the lens when not used; a recess being each disposed on both sides on the bottom of the mouse; a hook being received in the recess by having one end of the hook pivoted into one end of the recess; both hooks when pulled out of their respectively recesses to hang the mouse on an upper edge of a monitor for mouse to serve as a network camera; and when each hook being pushed into the recess and the dustproof lid being closed to protect the lens for the mouse to function as a mouse.

### BACKGROUND OF THE INVENTION

(a) Field of the Invention

The present invention is related to a mouse adapted with a network camera, and more particularly, to one provided at its bottom a window, a dustproof lid disposed on the window, a lens built in the window, a slot each respectively provided on both sides of a base of the mouse, a hook pivoted to each slot to be either pushed into the slot or pulled out to suspend on an upper edge of a monitor for the mouse to function also as a network camera.

(b) Description of the Prior Art

A mouse or a network camera respectively serves its single purpose. The mouse has a given volume to facilitate its user to hold with his palm while the network camera may be hooked upon an upper edge of a monitor or placed on a desktop. While the user executes video transmission with the network camera, the mouse is usually idled other than providing real-time displaying function of the picture in conjunction with a keyboard.

However, the prior art is found with the following flaws:

1. The mouse provides the user to scroll on the monitor and select a functional key without allowing the user to access to the functional of the network camera either for regular or provisional use.

2. Similarly, the network camera of the prior art can only provide video transmission function and fails to function as a mouse.

3. On the aspect of portability, both of the mouse and the network camera must be carried along to increase carrying space and purchase cost.

4. With both of the mouse and the network camera, more USB communication series ports are needed. However, the number of the USB communication series ports is very limited on the average notebook to cause inconvenience to the user since the number of channels available for other peripherals would have to be reduced.

### SUMMARY OF THE INVENTION

The primary purpose of the present invention is to provide a mouse adapted with a network camera for achieving the dual benefits in one. To achieve the purpose, a window is provided at where appropriate on the base of the mouse; a lens is provided built in the window; and a dustproof slide lid is provided on the window so to cover up the lens when the network camera is not used. An accommodation recess is provided on each of both sides on the bottom of the mouse, and one end of a hook is pivoted into each accommodation recess. Both hooks are pulled out to hang the mouse on an upper edge of a monitor, and the dustproof lid is pushed open to expose the lens for operating the network camera. When the use of the network camera is not desire, both hooks are pushed back in their respective recesses for the mouse to serve its purpose.

### BRIEF DESCRIPTION OF THE DRAWINGS

FIG. 1 is a perspective view of the present invention as assembled.

FIG. 2 is a schematic view showing an operating status of a mouse of the present invention.

FIG. 3 is another schematic view showing an operating status of a mouse of the present invention.

FIG. 4 is a schematic view showing an operation of using the mouse as a network camera of the present invention.

FIG. 5 is a perspective view showing a preferred embodiment of the present invention using a mouse to function as a network camera.

### DETAILED DESCRIPTION OF THE PREFERRED EMBODIMENTS

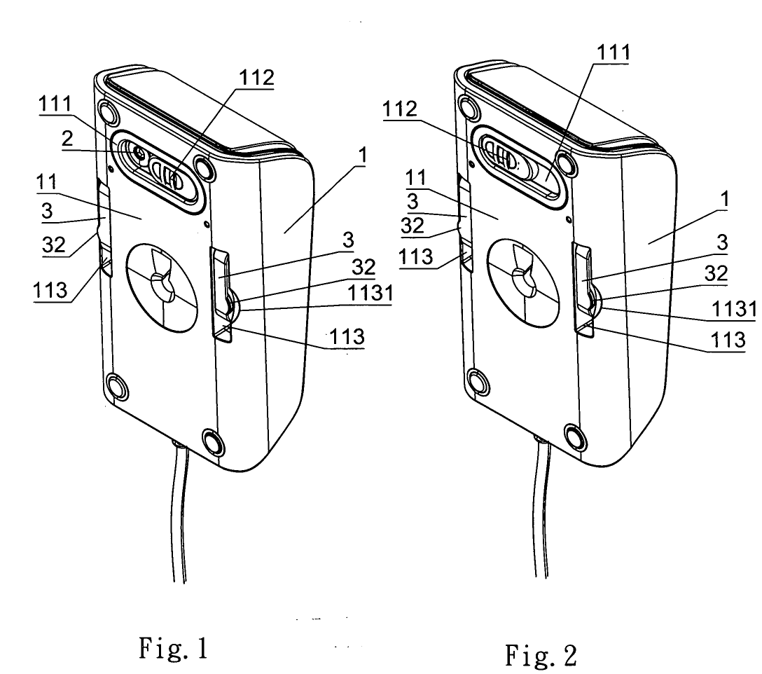

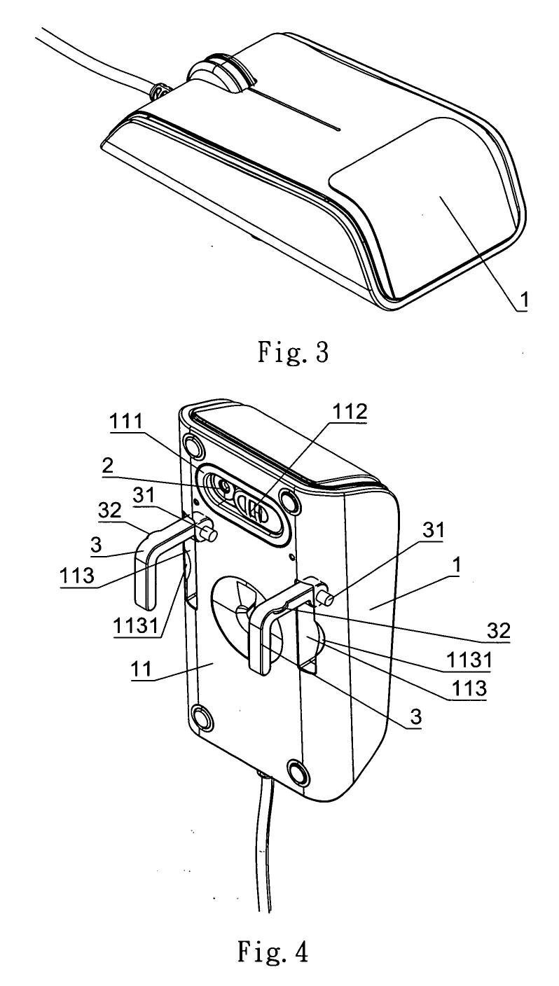

Referring to FIGS. 1 and 2, a window 111 is provided at where appropriately on a base 11 of a mouse 11; a lens 2 is built in the window 111; a dustproof slide lid 112 is provided on the window 111 to cover up the lens when a network camera is not used as illustrated in FIG. 2 for protecting the lens and for the mouse 1 to serve its purpose as illustrated in FIG. 3 without affecting the expected function of the mouse.

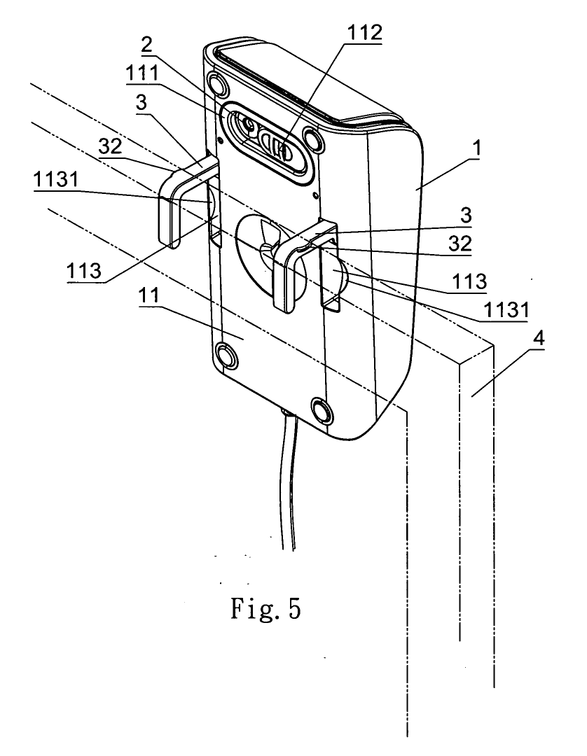

As illustrated in FIG. 4, an accommodation recess 113 is provided on each of both sides on the bottom of the base 11 of the mouse 1; and each recess 113 receives a hook 3 and the hook 3 has one end pivoted to the recess 113 by means of a pivot 31. When the use of the network camera is desired, each hook 3 is pulled up from the recess 113 with the pivot 31 as an axis to hang the mouse on an upper edge of a monitor 4 as illustrated in FIG. 5. The slide lid 112 is pushed open to expose the lens 2 for operating the mouse 1 as a network camera. When the function of a network camera is not desired, each hook 3 is turned over and pushed in to the recess 113 and the slide lid 112 is pushed on to cover up the lens 2 for the mouse 1 to serve its inherited function as illustrated in FIG. 3.

Now referring to FIGS. 1 through 5, a prying opening 1131 is provided on one side of each recess 113 for the hook 3 to be at where in relation to an ear 32 disposed on the prying opening, 1131. Accordingly, once the hook 3 is pushed into the recess 113, the ear 32 is merely received in the prying opening 1131 to facilitate a user to pull up the hook 3 from the recess 113 by digging up the ear 32.

What is claimed is:

1. A mouse adapted with a network camera includes a window disposed at where appropriately on a base of the mouse; a lens being built in the window in conjunction with the application of the network camera; an accommodation recess being disposed on each of both sides on the bottom of the base of the mouse; a hook being received in the recess; one end of the hook being pivoted into one end of the recess; both hooks being pulled up to hang the mouse on an upper edge of a monitor when the mouse is applied as a network camera; or each hook being turned over and received in the recess when the mouse is used as such.

2. The mouse adapted with a network camera as claimed in claim 1, wherein a dustproof slide lid is mounted on the window to be closed for protecting the lens or opened to expose the lens built in the lens.

3. The mouse adapted with a network camera as claimed in claim 1, wherein a prying opening is disposed on one side of each recess; an ear being disposed on the prying opening; each hook being located at where in relation to the ear; the ear merely being received in the prying opening when the hook is pushed into the recess to facilitate a user to pull up the hook by digging up the ear.
